(19) United States
(12) Patent Application Publication
(10) Pub. No.: US 2006/0169079 A1
(43) Pub. Date: Aug. 3, 2006

(54) Muffling structure of high-speed ball screw

(76) Inventors: Mao-Tu Lee, Taipei Hsien (TW); Hsun-Chen Lee, Taipei Hsien (TW)

Correspondence Address: Leong C. Lei, PMB#1008, 1867 Ygnacio Valley Rd., Walnut Creek, CA, 94598-3214, US

(21) Appl. No.: 11/047,553

(22) Filed: Feb. 2, 2005

(51) Int. Cl. F16H 25/22

(52) U.S. Cl. 74/424.82; 74/424.88

(57) ABSTRACT

A muffling structure of a high-speed ball screw is composed of a holder, a screw, at least one pair of corresponding rollers, seal rings and a sleeve. The holder has a central through hole which is provided with threads. At least one pair of hollowed out set-in grooves are correspondingly provided on the holder such that the roller rings can be inserted along the hollowed out set-in grooves into the interior hole of the holder, and that at least one pair of the disposed roller rings can totally cover the periphery of the screw, thereby the roller rings will become an oval shape to allow the steel balls to roll smoothly without any obstacle and to obtain a muffling effect over the high-speed rotating ball screw.

### BACKGROUND OF THE INVENTION

(a) Technical Field of the Invention

The present invention relates to a muffling structure of a high-speed ball screw, particularly to a ball screw design wherein the steel balls are installed and constructed in a way that when the screw rotates, especially under high-speed rotation, all the steel balls would not make noise due to friction and crash, thereby efficiently enhancing the convenience and silence of the assembly.

(b) Description of the Prior Art

Conventional ball screws are designed to allow metal rollers to roll in the threads of the screw without occurring any noise due to crash. As such, a plastic partition would be provided between every two metal rollers to serve as a crash barrier.

Accordingly, Japanese Lay-Open Patent No. 2000-355278 disclosed a structure of avoiding noise for a ball screw, which is provided with a steel ball retainer composing two thick retaining elements at the front and rear, respectively. A thin bending portion is connected between the two thick retaining elements, while a steel ball is filled into the space formed by the two thick retaining elements. The interior hole of the holder for the ballscrew is provided with threads for receiving the thin bending portion. A circulative pipe in nearly a “ [symbol] ” shape is provided at the top of the holder, while pluralities of hollowed out holes are provided at the bottom thereof, thereby the pressure blocks of the roller retainer can be installed into the hollowed out holes to format an integral groove path for the steel balls to circulative roll thereon. However, in view of the facts that the integral structure is complex, the numerous tiny components are hard to assembled, and the steel balls and the rolling elements for the roller retainer must be filled in one by one between the screw and the holder, the manufacture cost thus is relatively high. Accordingly, there are slim chances to reduce the manufacture cost, but greater chances to occur breakdown of the numerous tiny components.

Likewise, Japanese Lay-open Patent No. 2001-99257 is provided with pluralities of steel balls and a roller retainer. Connecting strips are provided around the pluralities of plastic partitions in the roller retainer, while inlet slot and outlet slot are provided on the holder, thereby the longish rolling elements formed by steel balls and the roller retainer can roll in the threads in a circulating manner. However, the longish rolling elements have a connecting head, which would interfere the smoothness of the rolling elements in the threads. Besides, as the circulating pipe outside the holder is in a “ [symbol] ” shape, rather than an arc path, it is likely that the steel balls cannot roll smoothly thereon, thus reducing the muffling effect.

In view of the above, the inventor researched to improve the noise that would occur during the rolling of the ball screw and disclosed the invention which can be applicable to various fields, be easily assembled, and reduce flaw rate of the products.

### SUMMARY OF THE INVENTION

The primary purpose of the present invention is to provide a muffling structure of a high-speed ball screw, which has a muffling function during the process of activating the steel balls and the screw when the screw reaches a high-speed rotation.

The secondary object of the invention is to provide a muffling structure of a high-speed ballscrew, which has an easy assembled structure that can acquire time efficiency, be applied to mass production, reduce flaw rate, and subsequently efficiently reduce the manufacture cost.

To obtain the above objects, the present invention is primarily composed of a holder, a screw, at least one pair of corresponding rollers, seal rings and a sleeve. The holder has a central through hole which is provided with threads. At least one pair of hollowed out set-in grooves are correspondingly provided on the holder such that the roller rings can be inserted along the hollowed out set-in grooves into the interior hole of the holder, and that at least one pair of disposed roller rings can totally cover the periphery of the screw, thereby the roller rings will become an oval shape to allow the steel balls to roll smoothly without any obstacle and to obtain a muffling effect over the high-speed rotating screw.

At least one pair of corresponding roller rings are provided in a manner that the circle of the holder is evenly divided thereby such that the steel balls in each of the roller ring will contact the screw in a range of a specific angle, and that the steel balls in the roller ring can roll in a path of a smooth oval without occurring any obstacle, thereby the ballscrew can rotate smoothly. The annular muffling chain and the steel balls are integrally combined together, thereby improving the speed and convenience of assembly.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view the present invention after being assembled.

FIG. 3 is a cut-away view of the invention after being assembled.

FIG. 4 is a cross-sectional view of the invention taken from 4-4 of FIG. 3.

FIG. 5 is an exploded view of the roller ring according to the invention.

FIG. 6 is a perspective view of the roller ring after being assembled.

FIG. 7 is a cross-sectional view partially showing the roller ring.

FIG. 8 shows assembling of the roller ring into the holder.

FIG. 9 is a perspective view of the exterior lining and the interior lining of another embodiment of the invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

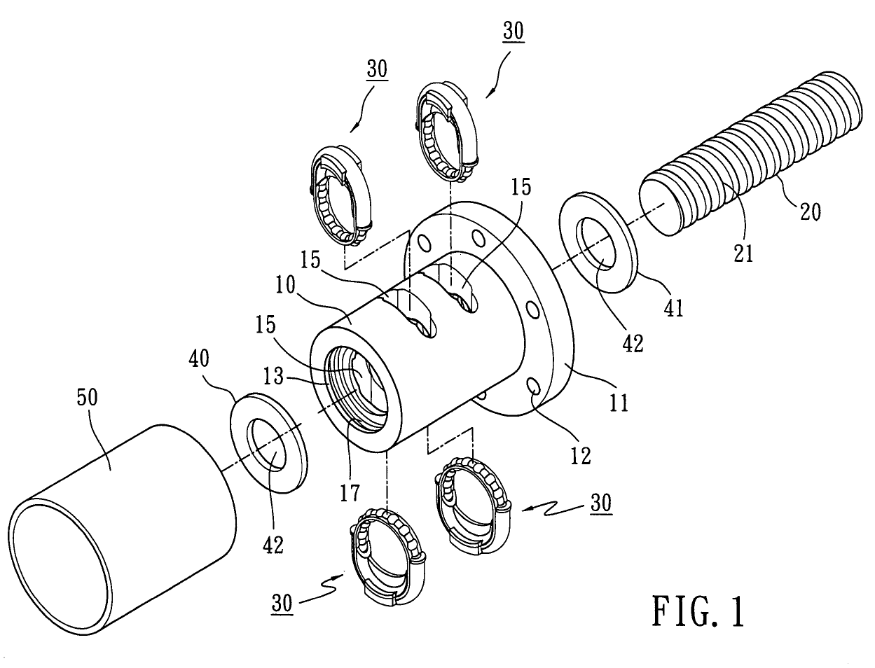

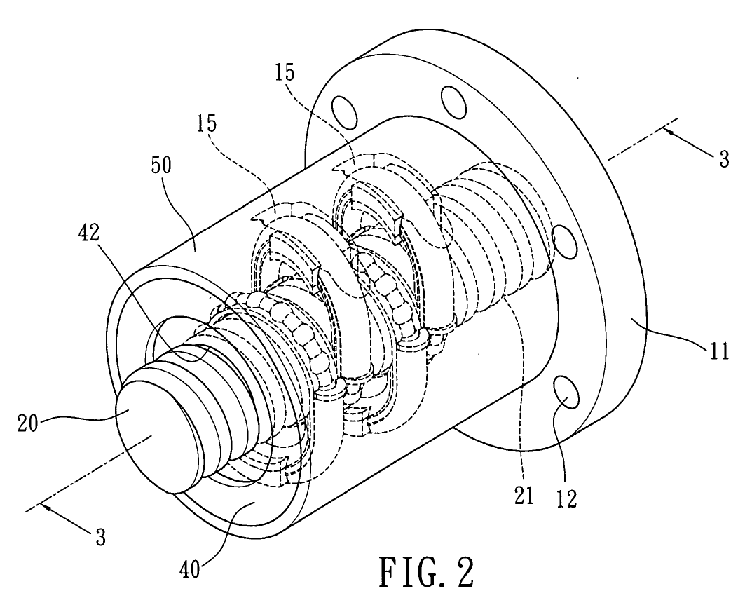

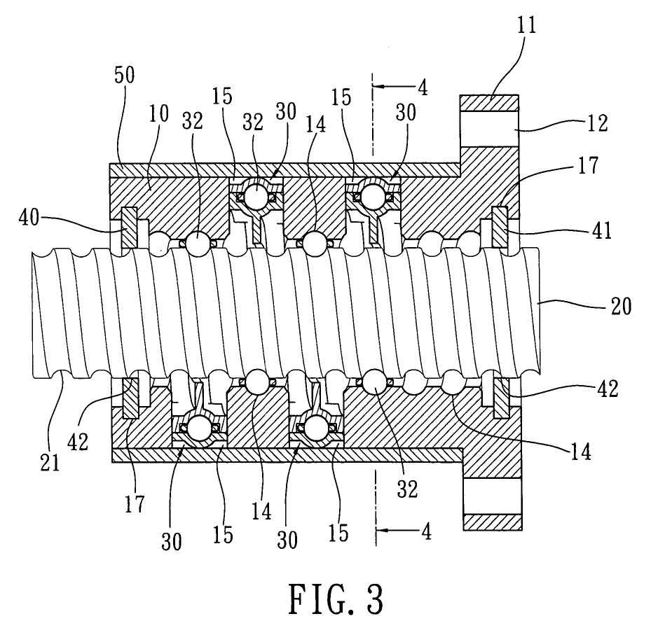

Referring to FIGS. 1 to 3, a muffling structure of a high-speed ball screw is primarily composed of a holder 10 in form of a cylinder, a screw 20, at least a pair of corresponding roller rings 30, two seal rings 40, 41, and a sleeve 50. The holder 10 is in form of a cylinder connected at one end with a flange 11 having a vertical wall. The flange 11 is provided with pluralities of holes 12 for receiving bolts (not shown) to be fastened to the other objects such as linear rail device. The holder 10 is provided at the center with an interior hole 13 having threads 14 (see FIG. 3) inside and corresponding hollowed out set-in grooves 15, i.e. one hollowed out set-in groove on the top of the holder 10, and the other one on the bottom corresponding thereto at an angle of 180°. The hollowed out set-in grooves 15 are disposed close to each other but parallel without intersection, and disposed along the direction of the threads 14 inside the holder 10.

As shown in FIG. 3, the holder 10 is provided with two hollowed out set-in grooves 15 on the top and the bottom, respectively. Given that the disposition is one hollowed out set-in groove 15 on the top and two hollowed out set-in grooves 15 on the bottom, it is still covered by the definition of “at least a pair of corresponding hollowed out set-in grooves.”

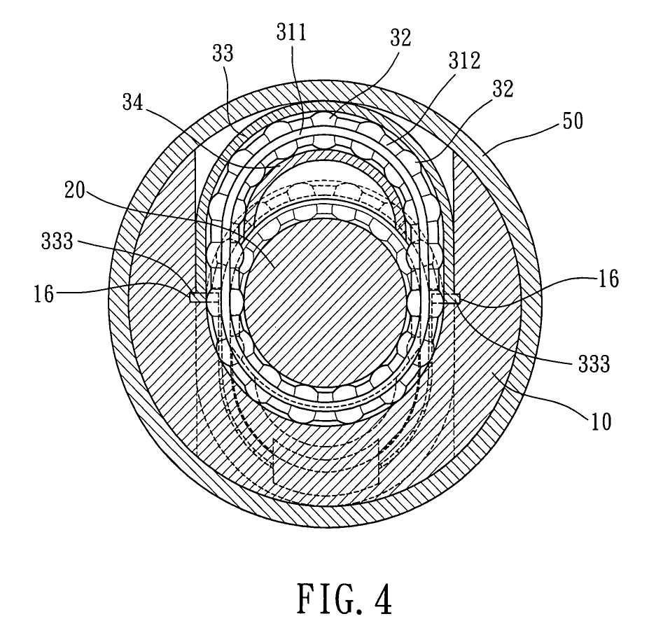

Now refer to FIG. 4, in a preferred embodiment of the invention, each of the hollowed out set-in grooves 15 has grooves 16 for positioning and engaging tongues 333 extruding from the bottom of the exterior lining 33 at the time when the roller ring 30 is disposed into the hollowed out set-in groove 15.

In FIG. 3, it is apparent that the front and rear edges of the interior hole 13 of the holder 10 is provided with annular grooves 17 for engaging with seal rings 40, 41. Lubricant can be infused into the reads 21 between the two seal rings 40, 41, such that the steel balls 32 can roll more smoothly. Each of the seal rings 40, 41 is provided with a central hole 42 for the screw to go through, in order to cover the hollowed out set-in grooves 15 for the purposes of anti-dust and noise-proof

Further referring to FIGS. 3 and 4, the invention is primarily provided with twin hollowed out set-in grooves 15 which are inserted with roller rings 30. By way of the contact of the steel balls 32 of the roller rings 30 and the threads 14 of the interior hole of the holder 10, as well as the threads 21 on the outer surface of the screw 20, the roller rings 30 can actually touch half periphery of the screw 20. However, by way of the disposition of the twin roller rings arranged up and down, the whole periphery of the screw 20 can be well contacted and thereby being positioned.

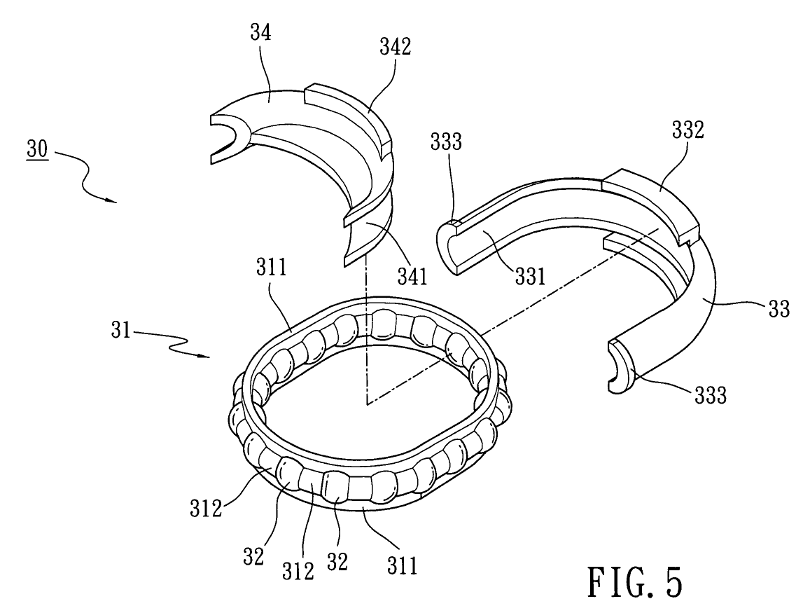

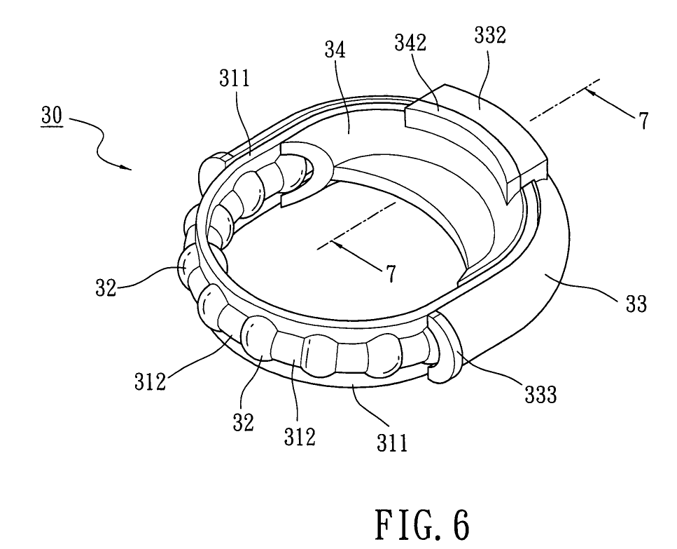

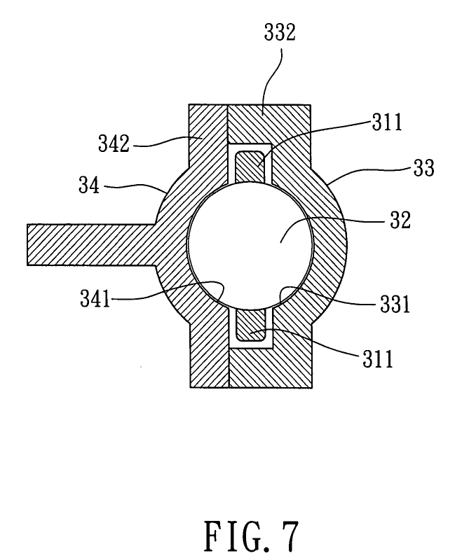

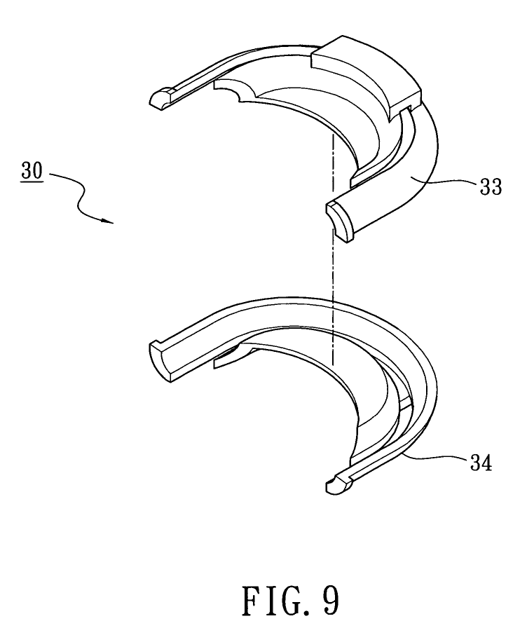

As shown in FIGS. 5 and 6, in a preferred embodiment of the invention, the roller ring 30 is composed of a rolling element including a muffling chain 31 and pluralities of steel balls 32, which is covered by an exterior lining 33 outside and an interior lining 34 inside. The rolling element rolls in a circular manner between the exterior lining 33 and the interior lining 34. The annular muffling chain 31 is provided with respective resistant strips 3 11 at two sides for connecting pluralities partitions 312. Each of the steel balls 32 is filled into the space formed by every two partitions 312 such that the steel balls 32 would not detach. The annular muffling chain 31 is in form of an oval such that stress concentration would not occur at the steel balls 32 when they are rolling. Besides, the exterior lining 33 provided at the outside of the rolling element formed by the annular muffling chain 31 and the steel balls 32 is provided with an arc groove 331 at the interior, locking flaps 332 at the outer rim, and extruding tongues 333 at the bottom, while the interior lining 34 provided at the inside of the rolling element formed by the annular muffling chain 31 and the steel balls 32 is provided with an arc groove 341 at the top and locking flaps 342 at the outer rim for combining with the locking flaps 332 (as shown in FIG. 7), such that the resistant strips 311 and the steel balls 32 of the roller rings 30 may go through the space formed by the exterior lining 33 and the interior lining 34 to allow the roller rings 30 roll via the steel balls 32 on the arc grooves 331, 341 on each lining. After the locking flaps 332, 342 of the exterior lining 33 and interior lining 34 are combined, the steel balls 32 can roll and contact the arc grooves 331, 341 of the exterior lining 33 and the interior lining 34. Meanwhile, the space formed by the exterior lining 33 and the interior lining 34 can alternatively be formed by two pieces disposed at the right and left sides of the roller ring 30 corresponding to each other (as shown in FIG. 9).

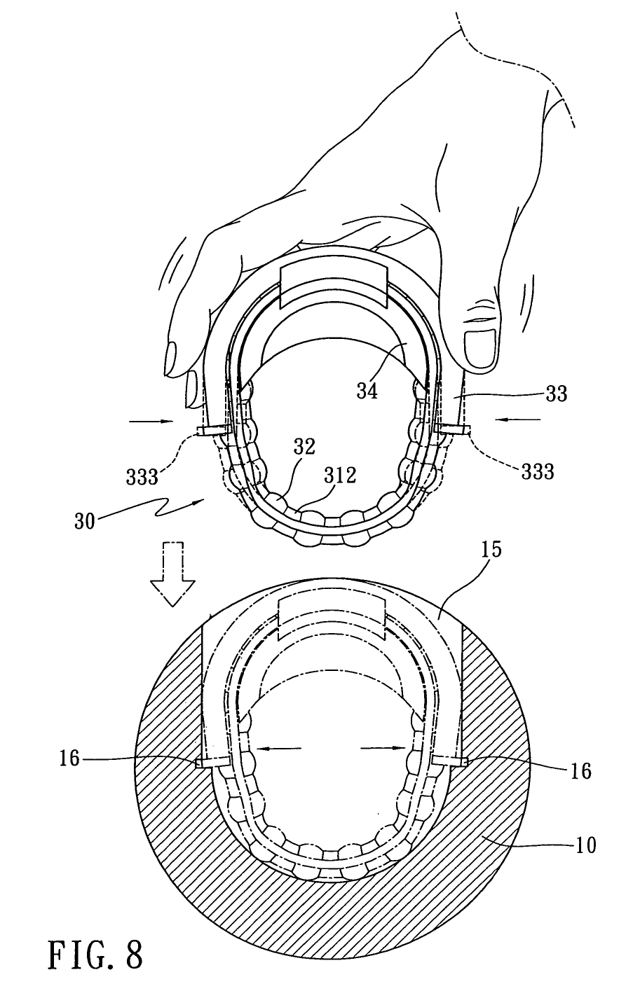

As shown in FIG. 8, in one embodiment of the invention, the hollowed out set-in grooves 15 are correspondingly provided at the opposite ends of the holder 10, and disposed along the interior threads 14 of the holder 10. To insert the roller rings 30 into the hollowed out set-in grooves 15, the roller rings 30 should be pressed to make the extending ends of the exterior lining 30 adjacent to each other, thereby narrowing the width between the two ends. The roller rings 30 are further pressed down into the holder 10 until the rolling rings 30 move into the bottom of the hollowed out set-in grooves 15. As the plastic material of the exterior lining 33 is flexible, the two ends thereof can flip out to make the extruding tongues 333 to automatically lock into the grooves 16 provided at the two sides of the bottom of the hollowed out set-in grooves 15 for positioning purpose. At least a pair (or alternatively two or more pairs) of or at least two corresponding roller rings 30 are filled into the prepared hollowed out set-in grooves 15. Accordingly, the roller rings 30 will surround the periphery of the screw 20, such that the roller rings 30 will be disposed along the direction of the interior threads 14 of the holder 10, as well as the direction of the surface threads 21 of the screw 20, thereby the surface of the steel balls 32, the threads 14 inside the interior hole 13 of the holder 10, and the threads 21 on the screw 20 will contact together.

It is worthy a mention that each hollowed out set-in groove 15 is disposed with the top and the bottom present 180°. Based on the same theory, in case each hollowed out set-in groove 15 is trisected (120°), or quartered (90°), the effect and intended claims are still within the scope of the present invention.

Concluded above, the application of the invention to the holder of the ball screw refers to providing hollowed out set-in grooves going through to the interior hole and the roller rings each composed of an annular muffling chain and pluralities of steel balls. The roller rings are inserted into the hollowed out set-in grooves to wholly cover the periphery of the screw, thereby the screw would not occur noise due to friction at the time of rotation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A muffling structure of a high-speed ballscrew, at least including a holder, a screw, and corresponding roller ring pair(s), wherein
the holder is in form of a cylinder connected at one end with a flange having a vertical wall, and provided at the center with an interior hole having threads inside and hollowed out set-in grooves around; and
the screw is provided with threads;
characterized in that:
an annular muffling chain is provided at its respective sides with resistant strips which are connected with pluralities of partitions having a steel ball inserted between every two of them such that the steel balls can be maintained without detachment;
roller rings, each of which is a rolling element composed of an annular muffling chain and pluralities of steel balls; the rolling element is covered by an exterior lining and an interior lining on its outer and inner surfaces, respectively, such that the rolling element will roll in a circular manner between the exterior and interior linings; when the roller rings are inserted into the hollowed out set-in grooves of the holder, the roller elements will be disposed inside the holder along the threads, thus the surface of the steel balls will contact with the threads inside of the holder and the threads on the screw, while the exterior lining would be combined inside the hollowed out set-in grooves of the holder;
thereby at least a pair of roller rings will be inserted, in intervals, into the hollowed out set-in grooves of the holder, such that the roller rings will be radially arranged at two sides of the screw corresponding to each other, and that the steel balls will circularly cover the threads of the screw to accomplish a muffling effect when the screw is rotating.

2. The muffling structure of a high-speed ball screw according to claim 1, wherein the holder is provided with annular grooves at the front and rear edge of the interior hole for receiving seal rings each of which is provided with a central hole for receiving the screw.

3. The muffling structure of a high-speed ball screw according to claim 1, wherein a sleeve is further provided for mounting outside of the holder to cover the hollowed out set-in grooves.

4. The muffling structure of a high-speed ball screw according to claim 1, wherein the roller rings are inserted into the hollowed out set-in grooves at the holder which is provided with more than one roller rings at the top and the bottom, respectively, while the number of the hollowed out set-in grooves is corresponding to that of the roller rings.

5. The muffling structure of a high-speed ball screw according to claim 1, wherein the bottom of each hollowed out set-in groove is provided with grooves.

6. The muffling structure of a high-speed ball screw according to claim 1, wherein the bottom of the exterior lining of the roller rings is provided with extruding tongues.

7. The muffling structure of a high-speed ball screw according to claim 1, wherein the periphery of the exterior lining of the roller rings is provided with locking flaps for combination with the locking flaps at the periphery of the interior lining.

8. The muffling structure of a high-speed ball screw according to claim 7, wherein the locking flaps of the exterior and the interior linings are combined together via a process of high frequency plastic melting.

9. The muffling structure of a high-speed ballscrew according to claim 7, wherein the space formed by the exterior and interior linings can be alternatively formed by two pieces disposed at the right and left sides of the ring roller corresponding to each other.
